(19) United States
(12) Patent Application Publication
(10) Pub. No.: US 2007/0182809 A1
(43) Pub. Date: Aug. 9, 2007

(54) Printing image frames corresponding to motion pictures

(75) Inventors: Rockwell N. Yarid, Churchville, NY (US); Martin E. Oehlbeck, Rochester, NY (US); Richard L. Druzynski, East Rochester, NY (US); Russell J. Palum, Rochester, NY (US); Terrence R. O'Toole, Webster, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/348,811

(22) Filed: Feb. 7, 2006

(51) Int. Cl. B41J 2/45

(52) U.S. Cl. 347/238

(57) ABSTRACT

A method of printing a plurality of image frames from a digital image file of a motion picture sequence to a photosensitive medium comprising one or more light-sensitive recording layers, comprising the steps of: a) providing at least one two-dimensional OLED modulator, wherein the OLED modulator comprises an array of independently activatable microcavity OLED elements, each OLED element defining an optical cavity for reducing the angle of emission of light from the OLED element and tuning the light output of the OLED element to a limited spectral band emmitance range wavelength matched to the spectral sensitivity of a light-sensitive recording layer of the photosensitive medium; b) responding to the digital image file to independently activate the OLED elements in the two-dimensional OLED modulator to provide visual images corresponding to each frame of the motion picture sequence; and c) moving the photosensitive medium past the visual images to illuminate different portions the medium to record the motion picture sequence on the medium.

### FIELD OF THE INVENTION

The present invention relates to a method and apparatus for printing image frames from a digital image file of a motion picture sequence.

### BACKGROUND OF THE INVENTION

Digital images have been printed onto photosensitive medium using systems based on liquid crystal display (LCD), digital micromirror device (DMD), lasers and acoustic optical modulators, cathode ray tubes (CRT) and electron gun as the primary means of modulating the illuminating sources to create the images. Some of these technologies in their current level of maturity used to print images onto motion picture photosensitive medium are known to have inherent limitations. CRT systems such as that described in U.S. Pat. No. 4,754,334 are slow, relatively large and generally do not have the capability to create images that make use of the full exposure range of the motion picture film because of the low radiance output of the CRT. It takes approximately 20 seconds to print a 2000 pixel resolution full aperture image using this system. The raster scan systems employs a spinning mirror called a scanner to impart motion to a focused modulated laser beam to expose and build the image one pixel at a time. A 2000 pixel resolution image can contain over 6 million pixels. The raster scan system may contain a single mirror or multi-mirror scanner. The limitations in such systems as described in U.S. Pat. No. 5,296,958 are due primarily to the limitations in speed of the scanner. The raster scan system is also relatively complex in its construction. It is estimated that the top end printing speed in a single beam, single mirror scanner system is about 1 second per a 2000 pixel resolution image using current commercial components and technology. It should be noted that no one has built such a fast system because of the cost and complexity involved. Electron beam systems are complex and the need to use special film types is a hindrance.

It is not practical to simply scale up these systems in order to gain speed. As an example, in order to print faster using a raster scan laser beam recorder, one could increase the speed of the scanner. Single mirror scanners (monogons) currently operate at approximately 65,000 RPMs, which is approximately the top end of their capabilities. Multi-mirror scanners (polygons) with 16 mirror facets are currently used today operating at approximately 6,500 RPM. In order to print faster, the scanners will have to operate at higher speeds but there are practical limitations relative to speed, the number of scanner mirrors, and the diameter of the scanner disk and cost. For example, the scanner motor loading varies as a function of the fifth power of the diameter and the square of the speed. It is possible to go faster but such an effort would result in added complexity, such as placing the scanner in a vacuum chamber to protect it and reduce drag. The power density of the writing spot may have to increase and the exposure time may have to decrease which could lead to reciprocity failures in the photosensitive medium.

Two-dimensional spatial light modulators, such as those using a digital micromirror device (DMD) from Texas Instruments, Dallas, Tex., or a liquid crystal display (LCD) from Victor Company of Japan, Limited (JVC) can be used to modulate an incoming optical beam for imaging. A spatial light modulator can be considered essentially as a two-dimensional array of light-valve elements, each element corresponding to an image pixel. Each array element is separately addressable and digitally controlled to modulate incident light from a light source by modulating the polarization state of the light. Polarization considerations are, therefore, important in the overall design of support optics for a spatial light modulator.

There are two basic types of LCD spatial light modulators currently in use, transmissive and reflective, respectively. Spatial light modulators have been developed and used for relatively low resolution applications such as digital projection systems and image display in portable devices such as TV and helmet display. Applications and teachings can be found in U.S. Pat. Nos. 5,325,137, 5,808,800, and 5,743,610. The requirements for projection and displays systems differs significantly from the requirements for high resolution printing to a photosensitive medium as would be required, for example, by the motion picture industry.

The images from the first generation high-resolution photosensitive medium will ultimately be used for creating a print film to be used for projection on a screen in a theatre. The process for creating the final projectable photosensitive medium would involve several generations of duplications and modifications by computer systems prior to the creation of the projectable medium. When viewing these intermediate high resolution photosensitive medium outputs or electronically scanning the original medium with a high resolution scanner, image artifacts, aberrations and nonuniformity will be more obvious. Optical systems for projectors and display applications are designed for the response of the human eye which, when viewing a display, is relatively insensitive to image artifacts, aberrations and nonuniformity, since the displayed image is continually refreshed and is viewed from a distance. The color content and peak wavelengths that the human eye would be optimally responsive to is not necessarily optimal for specific types of photosensitive medias. Even more significant are differences in resolution requirements. Adapted for the human eye, projection and display systems are optimized for viewing at typical resolutions such as 72 dpi or less, but photographic printing used in the motion picture industry is generally printed at resolutions in excess of 1900 dpi. As a result of these requirements the optical, illumination, and image processing systems for a motion picture printer used in the motion picture industry can vary significantly from the aforementioned systems.

The current available resolution using digital micromirror device (DMD), as shown in U.S. Pat. Nos. 5,061,049 and 5,461,411 is not sufficient for the printing needs of the motion picture film industry and there is no clear technology path to increase the resolution. DMDs are expensive and not easily scaleable to higher resolution.

Low cost solutions using LCD modulators are described in U.S. Pat. Nos. 5,652,661, 5,701,185, and 5,745,156. Most involve the use of transmissive LCD modulators. While such a method offers several advantages in ease of optical design for printing, there are several drawbacks to the use of conventional transmissive LCD technology. Transmissive LCD modulators generally have reduced aperture ratios and the use of transmissive field-effect-transistors (TFT) on glass technology does not promote the pixel-to-pixel uniformity desired in many printing applications, especially that required in high resolution motion imaging. In order to provide high resolution, the transmissive LCD modulator's footprint would have to be several inches in both dimensions, which would make the design of a practical output projection lens unreasonable in both cost and size. Transmissive LCD modulators are constrained to either low resolution and/or small images unsuitable for use in motion picture industry applications.

Another spatial light modulator that can be used is a single digital image light amplifier (SD-ILA) LCD. This device incorporates an integral RGB color separating holographic filter that focuses the RGB components of full white light spectrum of an illumination source onto RGB sub-pixels of each pixel in the modulator. Such a device is available from Victor Company of Japan, Limited (JVC). The apparent benefit of this device is the ability to use a single white light illumination source instead of RGB color illumination sources to expose the medium and create an image. The problem with these devices in the motion picture printer application is that to obtain the needed high resolutions of 6 to 12 micrometer pixel pitch on 35 mm motion picture film, the LCD modulator would be relatively large. The design of the output projection lens would be costly and complex. Convergence of the three colors in a pixel would also be potentially a problem creating apparent and unacceptable color shifts and other artifacts in the image. The reflective LCD modulator systems mentioned above is one of the simplest methods available today for modulating an illuminating beam for creating images on a photosensitive medium. The benefits in an LCD modulated system is significant in the reduction of component cost in building a system compared to CRT, laser raster scan, electron beam systems. An LCD modulated system is fast in performing the task of writing the images to the photosensitive medium. A two hour motion picture film sequence contains 172,800 high resolution discrete images. It is becoming common to see more motion picture films originating from digital sources. To this end, there is a need to be able to print these images in totality in a very short period of time (typically under 10 hours) to meet the needs of the digital mastering market. It would nominally take approximately 192 hours using CRT, laser raster scan, or electron beam systems to print these 2 k resolution images on 35 mm film using one machine.

Organic electroluminescent (EL) devices or organic light-emitting diode (OLED) devices have also been recently proposed as alternatives to previously known flat panel display devices. Tang et al. (Applied Physics Letters, 51, 913 (1987), Journal of Applied Physics, 65, 3610 (1989), and U.S. Pat. No. 4,769,292, e.g., demonstrated highly efficient OLEDs. Since then, numerous OLEDs with alternative layer structures, including polymeric materials, have been disclosed and device performance has been improved. OLED devices typically comprise a substrate having formed thereon a bottom-electrode, an organic EL element including at least one light-emitting layer, and a top-electrode layer. The organic EL element can include one or more sub-layers including a hole injection layer, a hole transport layer, a light emitting layer, an electron transport layer, and an electron injection layer. While OLED devices have been suggested for use in digital printers for photographic media in U.S. Pat. Nos. 5,482,896 and 5,530,269, US2002/0118270, and WO 03/092259, such disclosures do not overcome all performance problems associated with the use of OLED devices in such application.

In particular, the vast majority of OLED teachings are currently targeted for applications in equipment requiring color display systems with low power consumption such as portable phones, TV monitors and computers to name a few. In these applications, a viewing angle as well as the human eye response relative to the color spectrum is an important consideration in the design of the OLED array. It is more desirable to have a fairly wide viewing angle, which can be as wide as 160 degrees. Such a wide divergence angle would be a problem in the design of a film printer system, as a divergence angle of approximately 15 degrees would be more preferred from an optical collection point of view.

Another characteristic of OLED arrays commonly found in display systems is the wavelength of light emitted. The human eye response as depicted by the CIE Photopic sensitivity curve shows the perceived brightness of light energy between 400 to 730 nm. The human eye is most sensitive to 555 nm. The human response to wavelengths greater and less than 555 nm falls off equally and steadily. The wavelength typically used in OLED display systems for each of the three primary colors are typically 450 nm, 555 nm, 625 nm. Motion picture negative film typically used in the motion picture industry, such as Eastman Kodak Company ECN 5242, on the other hand, has as a different response to these wavelengths. Still another concern in the use of OLED arrays for printing applications is the broadband nature of each of the three primary colors typically employed in OLED displays. A broadband light source can easily cause cross talk between colors records on photographic film and produce images that are unacceptable. For example, broadband light in the green color record can expose the blue or red color record on film, this unwanted exposure will add to the normal exposure for the respective color channels and create false or contaminated color images.

It is in the interest of science and the business world to improve on the best of the existing systems and to find other methods that will reduce cost and complexity of any system. Accordingly it is an object of the invention to provide a method and apparatus that minimizes the above noted problems by using two-dimensional organic light emitting diode (OLED) displays, as modulators, to convert digital images to create images onto motion picture photosensitive medium.

### SUMMARY OF THE INVENTION

In accordance with one embodiment, the present invention is directed towards a method of printing a plurality of image frames from a digital image file of a motion picture sequence to a photosensitive medium comprising one or more light-sensitive recording layers, comprising the steps of:

a) providing at least one two-dimensional OLED modulator, wherein the OLED modulator comprises an array of independently activatable microcavity OLED elements, each OLED element defining an optical cavity for reducing the angle of emission of light from the OLED element and tuning the light output of the OLED element to a limited spectral band emmitance range wavelength matched to the spectral sensitivity of a light-sensitive recording layer of the photosensitive medium;

b) responding to the digital image file to independently activate the OLED elements in the two-dimensional OLED modulator to provide visual images corresponding to each frame of the motion picture sequence; and

c) moving the photosensitive medium past the visual images to illuminate different portions the medium to record the motion picture sequence on the medium.

In accordance with a further embodiment, the present invention is directed towards an apparatus for printing a plurality of image frames from a digital image file of a motion picture sequence to a photosensitive medium comprising one or more light-sensitive recording layers, comprising:

a) at least one two-dimensional OLED modulator, wherein the OLED modulator comprises an array of independently activatable microcavity OLED elements, each OLED element defining an optical cavity for reducing the angle of emission of light from the OLED element and tuning the light output of the OLED element to a limited spectral band emmitance range wavelength;

b) means for receiving and storing a digital image file of a motion picture sequence;

c) means for responding to the digital image file to independently activate the OLED elements in the two-dimensional OLED modulator to provide visual images corresponding to each frame of the motion picture sequence; and

d) means for moving a photosensitive medium past the visual images to illuminate different portions the medium to record the motion picture sequence on the medium.

### Advantages

The method and apparatus of the present invention provides a digital printer system based on microcavity Organic Light Emitting Diodes (OLEDs) that will have improved performance over CRT, laser raster scan and electron beam as well as an LCD modulator based systems, and that overcomes problems associated with use of non-microcavity devices in digital printer systems.

### BRIEF DESCRIPTION OF THE DRAWINGS

FIG. 1 is a schematic diagram of an apparatus for printing image frames corresponding to a motion picture film sequence in accordance with one embodiment of the present invention;

FIG. 2 is a detailed view of a configuration of an OLED modulator assembly in accordance with an embodiment of the invention;

FIG. 3 is another configuration of an OLED modulator assembly in accordance with an embodiment of the invention;

FIG. 4 is yet another configuration of an OLED modulator assembly in accordance with an embodiment of the invention;

FIG. 5 is yet another configuration of an OLED modulator assembly in accordance with an embodiment of the invention; and

FIG. 6 is yet another configuration of an OLED modulator assembly in accordance with an embodiment of the invention;

FIG. 7 is an example of an active matrix OLED modulator with a cutaway schematic showing one example of electrical circuitry that can used to independently activate each OLED device;

FIG. 8 is an example of an active matrix OLED modulator showing a cross-sectional schematic diagram illustrating three pixels of an OLED modulator.

### DETAILED DESCRIPTION OF THE INVENTION

The present invention is particularly suited for printing frames of either monochromatic (e.g., black and white) or full color motion pictures images. Digital image files for such motion pictures images can either be generated by a digital camera, scanned from images recorded on a photographic medium, or can be computer generated digital images.

Organic Light Emitting Diode (OLED) arrays can be made as a two dimensional monochromatic array of pixels or as a multi-color (e.g., red, green, blue tri-color) side by side pixel array, or even as a tri-color stacked pixel array. The array sizes, pixel pitch and aspect ratios can be made in a variety of resolution and densities. Each pixel site in a tri-color side by side or stacked array is composed of three light emitting diodes of different colors. Each light emitting diode in a tri-pixel site and therefore the entire array can be individual controlled to produce an effect similar to that of a color cathode ray tube in a television system to create a single color visual image. Each pixel site contains an appropriate red, green and blue light emitting diode the combination of which can produce colors throughout the spectrum of visible light. Three monochromatic arrays each of different colors can be combined to create a single color visual image.

For effective use as a printhead in a digital print process, the image presented on the OLED array needs to be optically focused on the medium to create a latent image. The wavelength of the different color light emitting diodes needs to be carefully selected or tuned to match the spectral sensitivity of the medium in order to create an image with color and density as was intended by the data in the digital image file. When printing images on traditional color motion picture film, three primary colors of monochromatic red, green and blue light may be used to create the image. Each primary color corresponds to one of the three separable color records in the digital image data and color planes on the photographic medium. Each separable color record in the image file would be presented to the respective color LEDs in the tri-color OLED array or to the respective monochromatic OLED arrays (as many monochromatic OLED arrays as there are color records) to create a visual image which would be focused on the medium to expose the three separable planes. The wavelength of these sources will generally desirably be in the approximate range of 650 nm (red), 540 nm (green) and 450 nm (blue). For a monochromatic image only one image plane is on the medium, therefore only one of the three sources of light in the OLED array would be used to create the image.

Monochromatic OLED displays can be effectively used to produce image frames. The present invention can make use of an organic light emitting diode display with light-emitting diodes having particular wavelengths to produce a visual image. It is known in the art that a color digital image residing on a computer can be decomposed into its representative color records and each color record can be written to a tri-color OLED display thereby creating a color visual image. The visual image is focused on a photosensitive medium to expose and create a latent color image. If a black and white (monochromatic) image is needed only one of the OLED displays will be used.

LCD modulator based systems will replace CRT, laser raster scan and electron gun based printing systems as the technology matures. Unlike OLED modulator based systems LCD modulator based systems require separate sources of illumination to create a color visual image. The LCD modulator based systems work on the principles of polarized light and as such require additional optical systems to condition the polarization states of the illuminating light to and from the LCD modulator. It would be of great benefit to eliminate as many components as possible to reduce cost, complexity and light loss in a system. Two-dimensional color OLED displays used as modulators in accordance with the present invention can perform the task with the benefits described above.

As discussed above, OLED elements comprise first and second electrodes with at least one layer of light-emitting material therebetween. In accordance with the present invention, microcavity OLED elements are specifically employed. Microcavity OLED devices comprise an organic light-emitting layer disposed between two reflecting electrodes, each typically having over 30% reflectivity. In most cases, one of the reflecting electrodes is essentially opaque and the other one is semitransparent having an optical density less than 1.0. The two reflecting electrode mirrors form a Fabry-Perot microcavity that strongly affects the emission characteristics of the OLED device. Emission near the wavelength corresponding to the resonance wavelength of the cavity is enhanced and those with other wavelengths are suppressed. The net result is a significant narrowing of the bandwidth of the emitted light and a significant enhancement of its intensity. The emission spectrum is also highly angular dependent, which is useful for printing purposes in accordance with the present invention. Microcavity devices may also advantageously be tuned to different wavelengths by varying the spacing of the optical cavity between the two reflecting electrodes to provide different colored light outputs, while employing common light-emitting materials. The optical cavity may be tuned to a preferred frequency at which light is to be emitted, e.g., by carefully depositing layers of the required thickness. The light within the cavity will form a standing wave pattern at the desired frequency and with a reduced angle of emission.

The advantage of use of a microcavity OLED device in accordance with the invention is thus three fold. First, it can tune the emission wavelength to a desired value. Thus, one may choose from a broader selection of emissive materials to achieve the proper emission color. Second, the microcavity narrows emission band width to minimize incorrect light exposure of the receiver film and makes calibration of the modulator easier. Third, a microcavity structure provides more directionality to light emission, specifically more light is emitted normal to the plane of the electrodes and less at angle. Contrary to many display applications where this is undesirable, this is a highly desirable feature in this invention. This provides better resolution and improved power efficiency to the modulator.

Optical cavities of this type are known in the art. For example, see US 2003/0184892 by Lu et al., which is incorporated herein by reference. When constructing an OLED modulator with microcavity structures, preferred anode and cathode materials are silver, gold, and aluminum due to their high reflectivity and low absorption. Most preferably, both the anode and cathode are made of silver. Of course, at least one of these electrodes must be semitransparent, that is, thin enough to allow light to pass. Further details with respect to microcavity OLED designs may be found, e.g., in US2004/0149984, US2004/0140757, and US2004/0155576, the disclosures of which are also hereby incorporated by reference. It is also possible to use optical cavity designs that produce coherent laser light as described in US 2003/0161368 and 2002/0171088 which are incorporated herein by reference.

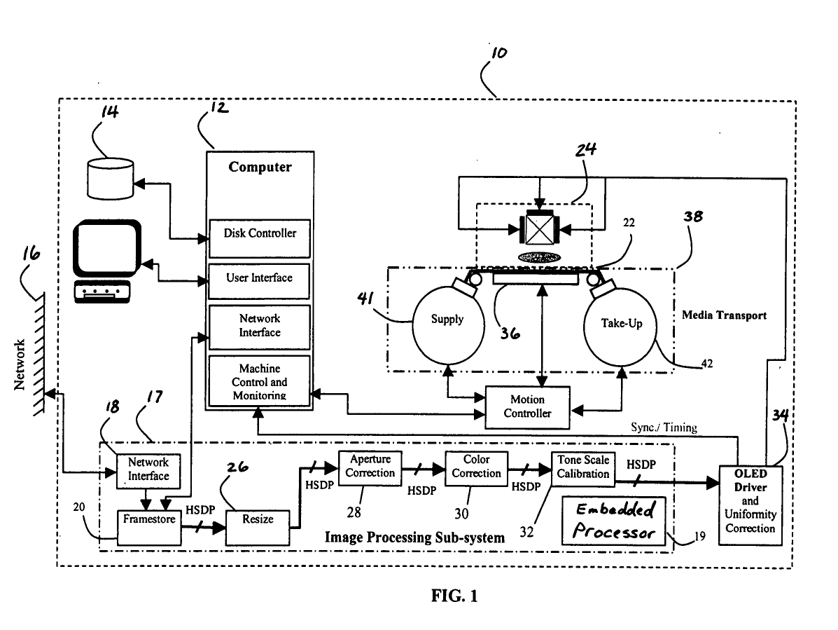

Turning now to FIG. 1, in accordance with one embodiment, an apparatus 10 is illustrated for printing at least three separable image records from a digital image file of a motion picture sequence where such a file is stored on a computer's 12 local disk 14 or on any convenient digital file storage means accessible to the computer where such means could be on an external network 16 storage means. As will become clearer, the image digital file will be used to activate each of the two-dimensional monochromatic OLED modulators to create a single color visual image. Network interface 18 provides a common entrance point for the digital image file to be retrieved from the external network 16, whereas image files from the local disk would enter directly into the framestore 20. The apparatus 10 responds to the digital image file that contains discrete digitized color motion images or discrete digitized black and white motion images from which are produced color or monochromatic visual images to be recorded on the photosensitive medium 22. The color visual image on the modulator assembly 24 is composed of one or more color channels corresponding to at least one or more of the separable color records in the digital image file of the color or black and white motion picture frame.

Digital images can be created from the output of a digital motion or still image camera or by computer generated graphics or by digitally scanning photographic images off of a photosensitive medium. The means of storing digital images are varied which could include storage on compact optical disk, magnetic tape, or traditional computer disk. Once stored in a file they can be made accessible to computer systems where they can be manipulated and viewed. It is very important that the digital images, when created and stored, are stored in some standard graphical image format such as JPEG, TIFF or DPX. A format defines how the digital information should be interpreted in order to reconstruct the image. A series of images, each called a frame, which differ from each other in a small and ordered sequence and viewed in this sequence at some specific frame rate, will give the effect of motion to an observer. This is the process used for projecting a movie on a screen for well over 90 years.

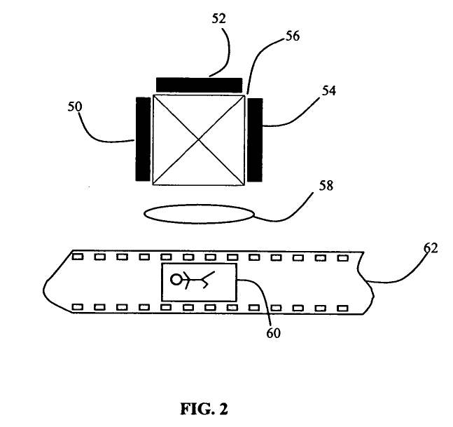

In the preferred embodiment the modulator assembly 24 contains three activatable two-dimensional monochromatic OLED modulators each of a different color. FIG. 2 is a detailed view of the modulator assembly 24. Turning now to FIG. 2, the assembly includes a red activatable two-dimensional OLED modulator 50, a green activatable two-dimensional OLED modulator 52 and a blue activatable two-dimensional OLED modulator 54. Each two-dimensional monochromatic OLED modulator has predetermined pixels in which color monochromatic visual images corresponding to each motion picture frame can be produced. Each pixel can be selectively activated. Activatable two-dimensional monochromatic OLED modulators comprising microcavity OLED elements can be manufactured as taught in the above cited references, employing further conventional manufacturing techniques employed in manufacture of OLED devices by Sanyo of Japan, eMagin Corporation and the Eastman Kodak Company in the US, to name a few.

FIG. 2 is a detailed view of a particular embodiment of the modulator assembly 24. Turning now to FIG. 2, the color visual images from each of the two-dimensional monochromatic OLED modulator are combined by an X-cube 56. The X-cube has the appropriate dichroic coatings on the internal surfaces to reflect or transmit specific wavelengths of light. The visual images from the red two-dimensional OLED modulator 50 and the blue two-dimensional OLED modulator 54 are reflected by the internal surface of the X-cube 56 at right angles to allow the visual images to be projected on to the focusing lens 58. The visual image from the green two-dimensional OLED modulator 52 passes through the X-cube 56 onto the focusing lens 58. The three color visual images projected onto the focusing lens 58 are superimposed and precisely registered to within a required tolerance. The focusing lens 58 will magnify or demagnify the combined color visual image to create a focused color visual image 60 on a plane that is incident on the photosensitive medium 62.

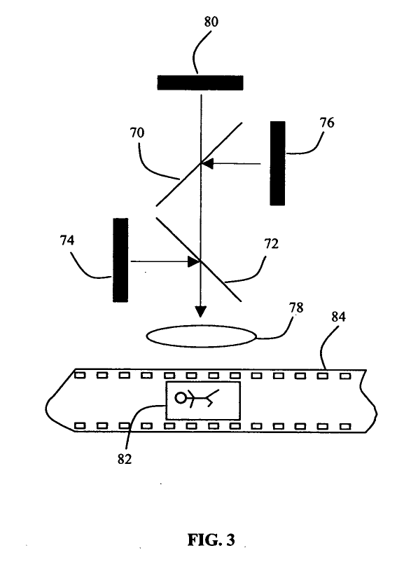

FIG. 3 is yet another configuration of the modulator assembly 24 shown in FIG. 2. Turning now to FIG. 3, two dichroic beam splitters 70, 72 are used to replace the X-cube combiner of FIG. 2. The visual images from the green two-dimensional OLED modulator 74 and the blue two-dimensional OLED modulator 76 are reflected by their respective dichroic beam splitters 70, 72 towards and onto the focusing lens 78. The visual image from the green two-dimensional OLED modulator 80 passes through the two dichroic beam splitters 70, 72 onto the focusing lens 78. The three visual images projected onto the focusing lens 78 are superimposed and precisely registered to within a required tolerance. The focusing lens 78 will magnify or demagnify the combined color visual image to create a focused color visual image 82 on a plane that is incident on the photosensitive medium 84.

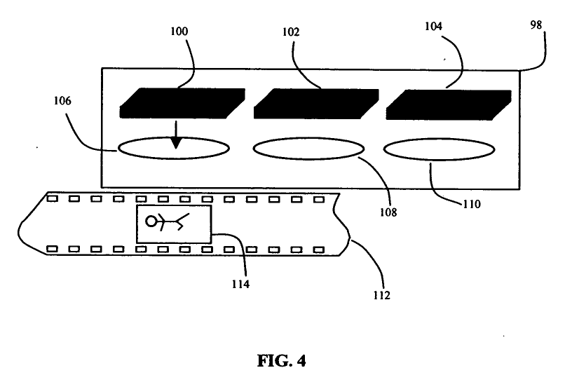

Still yet another configuration of the modulator assembly 24 is shown in FIG. 4. The three two-dimensional monochromatic OLED modulators 100, 102, 104 are positioned in a fixed relationship to each other and with individual focusing lens 106, 108, 110 in a modulator assembly 98. The three two-dimensional monochromatic OLED modulators 100, 102, 104 are such that the image bearing face of the modulators are along the same plane and the visual image on each is oriented similar to each other. The spacing between each modulator is similar and fixed. The modulator assembly 98 is also oriented such that the image bearing surface of each two-dimensional monochromatic OLED modulators 100, 102, 104 is oriented in an image bearing relationship with the surface of the photosensitive medium 112. The visual image from each two-dimensional monochromatic OLED modulator 100, 102, 104 is magnified or reduced by their respective focusing lenses 106, 108, 110 onto an image plane 114 which is incident on the photosensitive medium 112.

The photosensitive medium 112 is contained within and supported by the film gate 36 located in the media transport assembly 38. The film gate 36 and media transport will transport the photosensitive medium along its length from the supply canister 41 to the take-up canister 42 after each image is exposed onto the photosensitive medium. The media transport assembly will, initially for each image, cause an unexposed portion of the photosensitive medium 112 to be registered, in an image bearing relationship, under the blue focusing lens 106. The blue visual image will then be used to exposed the photosensitive medium after which the modulator assembly 98 will be moved along the direction of the length of the photosensitive medium 112 in such a manner as to bring the modulator assembly's 98 green focusing lens 108 into the precise position previously occupied by the blue focusing lens 106 and in an image bearing relationship superimposed on the blue latent image previously created on the photosensitive medium. The green visual image will be used to expose the photosensitive medium 112 after which the process will be repeated to expose the red visual image as was done for the green visual image. After all color planes have been exposed the modulator assembly 98 will be repositioned to its initial starting position. The photosensitive medium 112 will be transported by the media transport assembly 38 to cause an unexposed area, according to the image aperture type, to be registered at an initial starting point under the blue focusing lens 106 where the process of creating an image will be repeated for the next image.

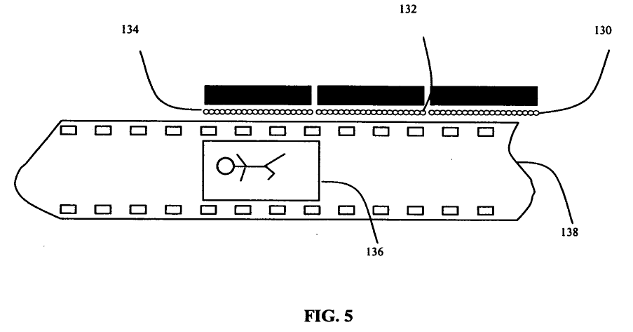

Yet another configuration of the modulator assembly 24 is shown in FIG. 5 that is very similar in configuration and operation to that of FIG. 4 with the exception that the focusing lens 106, 108, 110 associated with each two-dimensional monochromatic OLED modulators 100, 102, 104 is replaced with a selfoc or monolithic lenslet module (MLM) 130, 132, 134. These modules are an array of optical micro lenses built in such a way as to have the same size and pitch as the two-dimensional monochromatic OLED modulator it is intended to work with. Lenslet arrays are extremely small and precise in their design and manufacture. The fabrication, mating and alignment of such small devices is possible through the lessons learned through technologies developed in the field of microelectromechanical Systems (MEMS) and microfabrication technology. Monolithic Lenslet Modules (MLM) made by Adaptive Optics Associates, Inc. of Cambridge, Mass. in the US have been built as large as 12 inches by 12 inches with a lenslet pitch of 15 microns. Others such as Qudos Technology LTD in the UK claim to be able to fabricate microlenses down to a micron. Such microlens arrays are becoming common place in our world today. The type of two-dimensional OLED modulators needed in a OLED based printer system would have pixel pitch in the 6 to 15 micron range which provides a reasonable match to the capabilities of the optical fabrication of micro lens or lenslet arrays. There is a lenslet in the array for each LED pixel on the two-dimensional monochromatic OLED modulator.

While the use of microcavity OLED elements will minimize light divergence, the light output from each pixel site will still diverge to a degree, and a means of collecting and collimating this diverging light preferably may be provided. It is best to use a two-dimensional monochromatic microcavity OLED modulator with as small a divergence angle as can be obtained. Two-dimensional OLED display with a wide divergence angle are typically desired for use as a display, but for use as is proposed in this invention a small divergence angle, approaching 0 degrees, is desired. A lenslet array may be aligned and placed in front of the two-dimensional OLED modulator according to the design criteria of the lenslet array. The lenslet arrays should collect and collimate the light produced by each pixel in the respective two-dimensional OLED modulator. The color visual image from the output of each lenslet array 130, 132, 134 will be focused at the image plane 136 on the photosensitive medium 138.

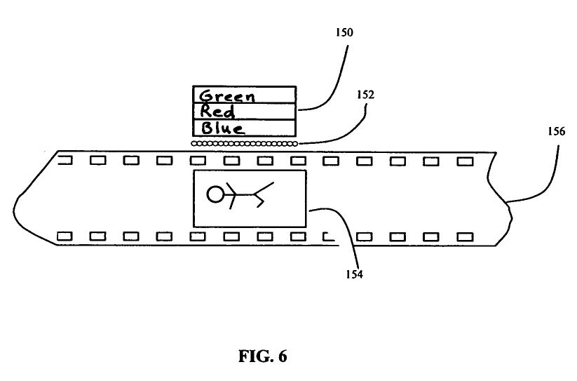

Yet another configuration of the modulator assembly 24 is that of FIG. 6 which is a stack of two-dimensional monochromatic OLED modulators each with a light output at a different wavelength utilizing selfoc or MLM lenslet arrays similar to that of FIG. 5. Turning now to FIG. 6, a two-dimensional tri-color OLED modulator 150 known as a stacked organic emitting device is fitted with a lenslet array 152 similar to that which was described in FIG. 5 for a two-dimensional monochromatic OLED modulator. Each of the three individual two-dimensional monochromatic OLED modulator visual image planes are superimposed on each other. In this particular embodiment, e.g., a microcavity OLED modulator may be employed as the modulator farthest from the image plane, with two OLED modulators comprising OLED elements having transparent electrodes closer to the image plan. Light emitted from all three OLED modulators travels in a direction towards the lenslet array 152 and photosensitive media 156. The resulting image from the lenslet array 152 is a color visual image that is focused on an image plane 154 on the photosensitive media 156. Each color image created is created simultaneously by the monochromatic images from each of the modulators in the two-dimensional tri-color OLED modulator 150.

In order to activate the activatable two-dimensional monochromatic OLED modulators, the following circuitry responds to the stored digital image as follows. A digital color image frame is comprised of one or more visual image planes each of which is a composite of pixels arranged in two dimensions which defines the aperture. The SMPTE 59-1998 standard defines the apertures used on 35 mm motion picture film. Each pixel is created on the medium using digital data from one or more of the separable color records corresponding to one or more of the separable color image planes on the photosensitive medium 22. In the case of a black and white images intended for black and white photosensitive medium 22 there is only one monochromatic image plane, therefore only one data file record is required. In the case of true color images, there are generally three data file color records and three image planes on the photosensitive medium 22.

Each color record defines the densities of the pixels for that color plane. Density might be measured, for example, in a metric such as Status M, Status A, or printing density depending on the types of photosensitive medium 22 to be used. The density of each color in a pixel can be represented by a value of some magnitude, which is referred to as the color bit depth. Such a magnitude can be represented by a digital value of n bits. An 8 bit value has a bit depth of 256 discrete density levels, and a 10 bit value has 1024 discrete density levels.

The digital image is transferred one frame at a time to the framestore 20 in the image processing sub-system 17 from the storage means 14 or 16. The image processing sub-system 17 provides a collection of processing functions that is configurable and controlled by the embedded processor 19 or programmable gate arrays. The processing of data requires a very high speed data path that may not be provided for within the general computer 12. The image processing sub-system 17 may be a specialized high speed external computer or a peripheral processing card or collection of cards within the computer 12. High speed processing elements such as FPGAs or ASICs might be employed to process the image data according to firmware program control. One such assembly is manufactured by Annapolis Micro System and is called a Wildstar II DSP.

The framestore 20 can hold several images at any one point in time depending on a number of design and operational needs, but generally only one image at a time is processed for printing. The framestore might perform simple data manipulation such as line reversal for printing positive or negative images where the physical placement of the image on the medium between a positive and negative image frame is different.

Each separable color record of a frame is then transferred from the framestore into one or more image processing elements as is dictated by the needs of the user. Image processing elements 26, 28, 30, 32 manipulates the digital image data to achieve certain results on the medium. These techniques are known in the art and can involve the process 26 of resizing the digital image to increase or decrease the physical aperture size on the medium. Another process known as aperture correction 28 is used to correct pixel defects that may have occurred as a result of data transmission of the digital image data. Aperture correction may also be used to sharpen or blur the image.

A color correcting processing step that can be performed on the digital image data is called color correction 30. The use of color correction may come as a result of the need to print the same images on different stock or batches of the photosensitive medium 22 or to match the spectral sensitivity of the medium. In some cases the image data is manipulated to achieve some special effects in the color mix of the image.

Tone scale calibration 32 provides a compensation to the digital image data that will correct for variability in the medium stock emulsion, chemical processing of the medium, and variations within the OLED modulators and/or optics. The purpose of tone scale calibration is an effort to produce an image that is consistent with the representation of the digital image regardless of medium stock, printer, and medium process variations. The digital image data may represent pixels in an image that are all of the same color and density, this is known as a flat-field image and is often used for image analysis purposes. A flat-field image, when printed without tone scale calibration, could result in a relatively higher or lower density than that which was defined in the digital image file. Tone scale calibration can also adjust the data prior to printing, using prior knowledge about the aforementioned variables to achieve the expected results. The image on the medium is adapted to meet the density and color requirements defined by the digital image data.

Another image processing need is that of file conversion. As was stated digital image files could be stored in many different standard formats (i.e. TIFF, JPG, DPX to name a few). Most of these standard formats have additional data that carries information about the file structure and content such as compression information if compressed, color bit depth, color data order sequence, sometimes even sub-sampled images. This additional information needs to be removed before the image can be presented to the activatable two-dimensional color OLED modulator. The image processing sub-system would need to convert all incoming digital image files to a standard internal native data format void of this additional non image content information. It is possible to convert between many of these formats. The embedded processor 19 could perform file conversion on the digital image file frames as they are received form the storage means to the internal format needed by the image processing sub-system.

The imaging area of a two-dimensional monochromatic OLED modulator 50, 52, 54 is a composite of pixel sites with an aspect ratio similar to the aperture format of an image frame. The number of pixel sites and two-dimensional spacing of them defines the resolution of the device. Current devices readily available have resolutions of 852×600 pixels (for tri-color side by side arrays). For a two-dimensional monochromatic OLED modulator the resolution would be higher because only one modulator would be used per color. It is very important in high resolution imaging applications that all pixel sites have uniform light output for each color channel over the full operating range. Ideally, all LEDs in an array would have equal light output over the full effective dynamic range within some specified tolerance. If this situation is not met, objectionable artifacts can result and be noticeable on the medium. Relative variations of 0.002 density on motion picture film negative (i.e. Eastman Kodak Company ECN 5242) will be perceived as objectionable by the human observer when printed to print film and projected on a screen. This variation on film of 0.002 density can be the result of transmission variations in pixel sites of ½%. In a two-dimensional OLED modulator it is possible to control the light output electronically to achieve the uniformity required.

In the uniformity correction section of the OLED driver electronics 34, is a simple form of correction, a predetermined correction factor is applied by adjusting gain and offset for each pixel color element within the OLED modulators to reduce the variations. The method and means of providing for this correction can be implemented by programmable look-up tables. One method of deriving the correction factors for each color LED in a pixel would require printing a full aperture flat-field image on the medium with no correction compensation applied to the OLED modulator. A flat-field image is a digital image wherein all pixels are of the same density. It is preferred that the density of the image is approximately mid-scale. The flat-field image on the medium is digitized at the maximum image aperture size and resolution to produce density data for all pixels in a color plane. A high resolution scanner or microdensitometer can be used to digitize the image. A resulting uniformity data map digital file is created from which relative variations in light out levels for each modulator can be determined. The data is converted from log space (density) to linear space (intensity) and the median light output level is determined. The correction factor for each LED in a two-dimensional monochromatic OLED modulator is the percentage deviation from the median point of each pixel in a color frame. These correction factors are applied to the image data by the OLED driver/uniformity correction board 34 at the time of printing an image.

The correction factors from the uniformity data map could be used to correct the image if applied to the digital image file directly while the data is in log space (density). This would require more processing time and digital file storage or modifications to the original digital image file, which may or may not be desirable.

The light output level correction values used by the OLED Driver 34 uniformity correction system could vary as a function of the specific color LED in a pixel on each of the OLED modulators 50, 52, 54 the color bit depth of the pixel, and as a function of the specific color plane. The light output level of each color LED in the OLED modulators is controlled by the density code value in the digital image file. It might be necessary, therefore, to provide many correction values where the number of correction values equals the product of the number of pixels in an OLED modulator, the number of separable color planes, and the color bit depth of each pixel. This represents a very large number of discrete values that are stored on computer 12 and loaded to the OLED driver 34 at power up. There are a number of alternative means of applying this correction known to the art. The corrected image data is presented to the OLED modulators 50, 52, 54 in accordance with the specific requirements of the device manufacturer.

It is necessary to control the maximum light intensity output of each two-dimensional monochromatic OLED modulator as well as the time duration that it is turned on and radiating light. The combination of the magnitude of the light power output and the time duration is known as the film exposure value. The log of the exposure value determines the density of the images on the medium. The standard equation D=log H (gamma of one and no offset included) is very commonly used in the industry to define this relationship, where D equals density and H equals exposure in lux-seconds. Controlling the magnitude and time limits the maximum density for each color plane. The intensity of each color LED in a pixel for each color plane is controlled by the OLED driver 34. In order to set the power output of the LEDs to a specific value, a data profile of power output versus input code value for each color channel would be generated and stored on the computer. Light power at the medium plane is sensed by a photosensor temporarily placed at the image plane. As the light level is systematically varied the light power level, as read by the photosensor, is read and stored by the computer 12. In this process, each color channel is set to maximum output, and the input code value is varied from 0 to maximum in discrete steps, and light power for each step is recorded. The resulting transfer functions can be used by the computer, in a simple look-up table fashion, to arbitrarily set the maximum exposure levels of each color channel.

Under program control from the computer the photosensitive medium 22 is positioned such that an unexposed area of the medium is located in the film gate 36. Each color record of an image frame activates the respective OLED modulator 50, 52, 54 respectively for a predetermined exposure time and power output level, which creates a latent image on the medium. Once an image frame exposure has been made, an unexposed area of the medium is again positioned to accept the next image frame, and the entire aforementioned sequence is repeated. This process is repeated until all images in the digital image motion picture sequence have been imaged onto the medium.

The two-dimensional monochromatic OLED modulators 50, 52, 54 are electronically activated in response to the digital image signal from the OLED driver 34. The visual image created is presented on the photosensitive medium 22 The media transport system 38 and gate 36 transports and hold the photosensitive medium precisely in an image bearing relationship to the combiner cube. Media transport system 38 includes the gate 36, which provides proper registration for the medium at the focused image plane on the gate 36. Supply 41 and take-up 42 cassettes provide in-feed of unexposed medium to the gate and collects the medium after exposure respectively. Also included in media transport system 38 is a tensioning (not shown) system that allows the exposed medium to be reeled safely into the cassette without fear of damage. Such an apparatus is the subject matter of U.S. Pat. No. 6,037,973 and technical paper published in the SMPTE Journal, Volume 107, Number 8, August 1998; Authors: Edmund DiGiulio and James Bartell, where in is disclosed the method, apparatus, application and control of a high speed precision film transport system used to transport the type of medium which is of primary interest to this invention.

The two-dimensional OLED modulator comprises an array of individually addressable OLED elements. Such addressing means can be performed using passive or active matrix electronic driving schemes. A passive matrix display is comprised of orthogonal arrays of anodes and cathodes to form pixels at their intersections, wherein each pixel further comprises an organic EL medium disposed between the anode and cathode. Each pixel acts as an OLED device that can be electrically activated independently of other pixels. In active-matrix displays, an array of OLED devices (pixels) are formed in contact with thin film transistors (TFTs) such that each pixel is activated and controlled independently by these TFTs.

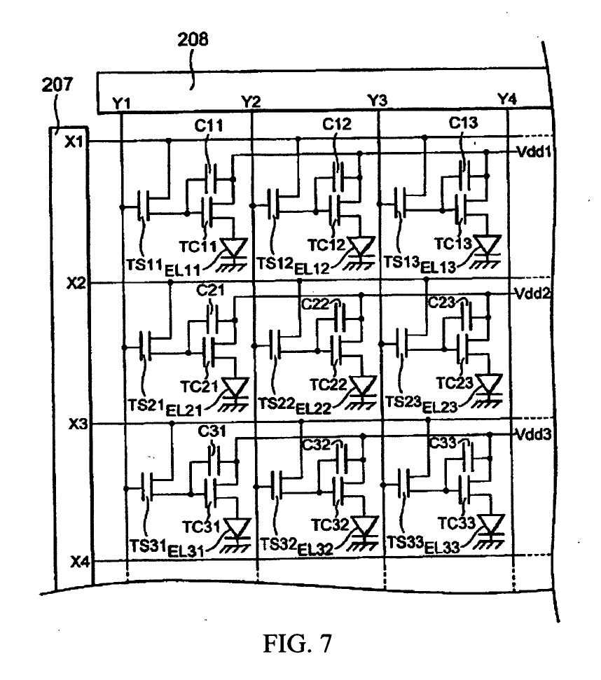

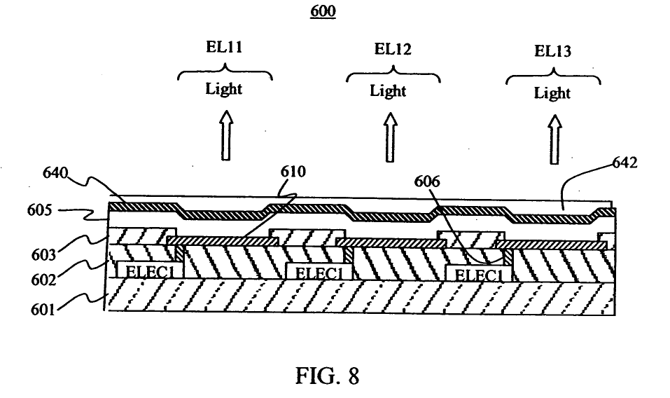

An example of a monochromatic active matrix OLED modulator is shown in FIGS. 7 and 8. FIG. 7 is a cutaway schematic showing one example of electrical circuitry that can used to independently activate each OLED device (i.e., each pixel). The active matrix array is composed of X-direction signal lines X1, X2, X3, . . . , Xn; Y-direction signal lines Y1, Y2, Y3, . . . , Ym; power supply (Vdd) lines Vdd1, Vdd2, Vdd3, . . . , Vddn; thin-film transistors (TFTs) for switching TS11, TS21, TS31, . . . , TS12, TS22, TS23, . . . , TS31, TS32, TS33, . . . , TSnm; thin-film transistors (TFTs) for current control TC11, TC21, TC31, . . . , TC12, TC22, TC23, TC31, TC32, TC33, . . . , TCnm; OLED devices EL11, EL21, EL31, . . . , EL12, EL22, EL23, . . . , EL31, EL32, EL33, . . . , ELnm; capacitors C11, C21, C31, . . . , C12, C22, C23, . . . , C31, C32, C33, . . . , Cnm; X-direction driving circuit 207, Y-direction driving circuit 208, and the like. Hereupon, only one pixel is selected by one of X-direction signal lines X1 to Xn and one of Y-direction signal lines Y1 to Ym, and a thin-film transistor for switching TS comes into the “on” state at this pixel, and due to this, a thin-film transistor for current control TC comes into the “on” state. Thus, an electric current supplied from a power supply line Vdd flows in the organic EL pixel, which results in light emission. Preferably, n and m are at least 1000. More preferably, n and m are at least 2000. Most preferably, n and m are at least 4000. In a preferred embodiment, the entire array of pixels can be addressed to yield an monochrome image corresponding to an entire frame of the receiving film.

FIG. 8 is a cross-sectional schematic diagram illustrating three pixels of a monochromatic OLED modulator 600. Modulator 600 comprises an array of organic electroluminescent devices (ELnm) that each emit the same color, usually red, green, or blue, to match the spectral sensitivity of the receiving film. If light emission is to occur through the support 601 (often referred to as a bottom-emitting modulator), then it is necessary that it and the organic insulator layers 602 and 603 provided over the support be at least partially transparent. If light emission is through the cathode 640 (a top-emitting modulator), then the optical properties of the support and insulator layers are immaterial. In modulator 600, cathode 640,is a common cathode provided over the entire modulator. When light emission is through the support, then cathode 640 is reflective. When top-emitting, the cathode should be semi-transparent to the wavelength of interest. For clarity, the electrical wiring, capacitors, and transistors in each pixel are designated by blocks ELEC11, ELEC12, and ELEC13, used to drive EL11, EL12, and EL13, respectively. Provided over organic insulator layer 602 is an array of anode pads, 610, that are connected to ELEC11, ELEC12, and ELEC13 by conductive wiring 606. If light emission is through the anode, the anode should be optically semi-transparent to the wavelength of interest. If light emission is through the top, then the anode is reflective. Organic insulator 603 is provided over organic insulator 602 and anode pads 610 and patterned to reveal the anode pads. Provided over the anode pads and organic insulator 603 is monochromatic light emitting organic layer 605. Layer 605 typically comprises several layers (e.g., a hole-injecting layer, a hole-transporting layer, a light-emitting layer, an electron-transporting layer) as known in the art. The thickness of these layers may be carefully controlled to achieve the desired optical cavity distance between electrodes 610 and 640. This is followed by deposition of cathode 640, which is common to each OLED device. Especially in the case of top-emitting modulators, it is desirable to provide thin layer encapsulation 642 over the entire device to protect it from moisture and oxygen. Encapsulation 642 can comprise several layers of inorganic and/or organic materials. The emission area of each OLED device (pixel) is defined by the contact area with the anode. In a preferred embodiment, modulator 600 is a top-emitting modulator. In a top-emitting configuration, the area of the anode and the resolution of the modulator can be maximized because the TFT circuitry does not block any emission area. In a conventional bottom-emitting configuration, the TFT and associated wiring can take 70% or more of the available space on the support. This leaves only 30% for the anodes. For top-emitting modulators, one can make the anodes larger for better efficiency and pack them more closely for better resolution. Another potential advantage for using a top-emitting modulator is that the distance between the surface of the modulator and the organic light emitting material is minimized. This can lead to better optical coupling of each signal to the receiver film with less cross talk between pixels. It should be further understood that, in an alternative embodiment, a common anode may be deposited over the top as layer 640 and the anode pads 610 may instead be cathode pads.

There are numerous configurations of the layers within OLED elements (device) known in the art wherein the present invention can be successfully practiced. The total combined thickness of the organic layers between the electrode layers is preferably less than 500 nm. Either the anode or the cathode may be in contact with the support. A voltage/current source is required to energize the OLED element and conductive wiring is required to make electrical contact to the anode and cathode. The TFT layers and associated wiring serve these functions. Substrates for use in this case include, but are not limited to, glass, plastic, semiconductor materials, ceramics, and circuit board materials.

Typical anode materials, partially transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes.

It is often useful that a hole-injecting layer be provided between an anode and a hole-transporting layer. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, and plasma-deposited fluorocarbon polymers as described in U.S. Pat. No. 6,208,075. Alternative hole-injecting materials reportedly useful in organic EL devices are described in EP 0 891 121 A1 and EP 1 029 909 A1. Metal oxides such as molybdenum oxide are also useful as a hole-injecting layer.

The hole-transporting layer contain at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al U.S. Pat. No. 3,567,450 and U.S. Pat. No. 3,658,520. A more preferred class of aromatic tertiary amines are those which include at least two aromatic tertiary amine moieties as described in U.S. Pat. No. 4,720,432 and U.S. Pat. No. 5,061,569. Illustrative of useful aromatic tertiary amines include, but are not limited to, the following:
1,1-Bis(4-di-p-tolylaminophenyl)cyclohexane
1,1-Bis(4-di-p-tolylaminophenyl)-4-phenylcyclohexane
4,4′-Bis(diphenylamino)quadriphenyl
Bis(4-dimethylamino-2-methylphenyl)-phenylmethane
N,N,N-Tri(p-tolyl)amine
4-(di-p-tolylamino)-4′-[4(di-p-tolylamino)-styryl]stilbene
N,N,N′,N′-Tetra-p-tolyl-4-4′-diaminobiphenyl
N,N,N′,N′-Tetraphenyl-4,4′-diaminobiphenyl
N,N,N′,N′-tetra-1-naphthyl-4,4′-diaminobiphenyl
N,N,N′,N′-tetra-2-naphthyl-4,4′-diaminobiphenyl
N-Phenylcarbazole
4,4′-Bis[N-(1-naphthyl)-N-phenylamino]biphenyl
4,4′-Bis[N-(1-naphthyl)-N-(2-naphthyl)amino]biphenyl
4,4″-Bis[N-(1-naphthyl)-N-phenylamino]p-terphenyl
4,4′-Bis[N-(2-naphthyl)-N-phenylamino]biphenyl
4,4′-Bis[N-(3-acenaphthenyl)-N-phenylamino]biphenyl
1,5-Bis[N-(1-naphthyl)-N-phenylamino]naphthalene
4,4′-Bis[N-(9-anthryl)-N-phenylamino]biphenyl
4,4″-Bis[N-(1-anthryl)-N-phenylamino]-p-terphenyl
4,4′-Bis[N-(2-phenanthryl)-N-phenylamino]biphenyl
4,4′-Bis[N-(8-fluoranthenyl)-N-phenylamino]biphenyl
4,4′-Bis[N-(2-pyrenyl)-N-phenylamino]biphenyl
4,4′-Bis[N-(2-naphthacenyl)-N-phenylamino]biphenyl
4,4′-Bis[N-(2-perylenyl)-N-phenylamino]biphenyl
4,4′-Bis[N-(1-coronenyl)-N-phenylamino]biphenyl
2,6-Bis(di-p-tolylamino)naphthalene
2,6-Bis[di-(1-naphthyl)amino]naphthalene
2,6-Bis[N-(1-naphthyl)-N-(2-naphthyl)amino]naphthalene
N,N,N′,N′-Tetra(2-naphthyl)-4,4″-diamino-p-terphenyl
4,4′-Bis{N-phenyl-N-[4-(1-naphthyl)-phenyl]amino}biphenyl
4,4′-Bis[N-phenyl-N-(2-pyrenyl)amino]biphenyl
2,6-Bis[N,N-di(2-naphthyl)amine]fluorene
1,5-Bis[N-(1-naphthyl)-N-phenylamino]naphthalene

Another class of useful hole-transporting materials includes polycyclic aromatic compounds as described in EP 1 009 041. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

As more fully described in U.S. Pat. No. 4,769,292 and 5,935,721, the light-emitting layer (LEL) of an organic EL element comprises a luminescent or fluorescent material where electroluminescence is produced as a result of electron-hole pair recombination in this region. The light-emitting layer can be comprised of a single material, but more commonly consists of a host material doped with a guest compound or compounds where light emission comes primarily from the dopant and can be of any color. The host materials in the light-emitting layer can be an electron-transporting material, as defined below, a hole-transporting material, as defined above, or another material or combination of materials that support hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material. Iridium complexes of phenylpyridine and its derivatives are particularly useful luminescent dopants. Polymeric materials such as polyfluorenes and polyvinylarylenes (e.g., poly(p-phenylenevinylene), PPV) can also be used as the host material. In this case, small molecule dopants can be molecularly dispersed into the polymeric host, or the dopant could be added by copolymerizing a minor constituent into the host polymer.

An important relationship for choosing a dye as a dopant is a comparison of the bandgap potential which is defined as the energy difference between the highest occupied molecular orbital and the lowest unoccupied molecular orbital of the molecule. For efficient energy transfer from the host to the dopant molecule, a necessary condition is that the band gap of the dopant is smaller than that of the host material.

Host and emitting molecules known to be of use include, but are not limited to, those disclosed in U.S. Pat. No. 4,768,292, U.S. Pat. No. 5,141,671, U.S. Pat. No. 5,150,006, U.S. Pat. No. 5,151,629, U.S. Pat. No. 5,405,709, U.S. Pat. No. 5,484,922, U.S. Pat. No. 5,593,788, U.S. Pat. No. 5,645,948, U.S. Pat. No. 5,683,823, U.S. Pat. No. 5,755,999, U.S. Pat. No. 5,928,802, U.S. Pat. No. 5,935,720, U.S. Pat. No. 5,935,721, and U.S. Pat. No. 6,020,078.

Metal complexes of 8-hydroxyquinoline and similar oxine derivatives constitute one class of useful host compounds capable of supporting electroluminescence, and are particularly suitable. Illustrative of useful chelated oxinoid compounds are the following:
CO-1: Aluminum trisoxine [alias,tris(8-quinolinolato)aluminum(III)]
CO-2: Magnesium bisoxine [alias,bis(8-quinolinolato)magnesium(II)]
CO-3: Bis[benzo{f}-8-quinolinolato]zinc (II)
CO-4: Bis(2-methyl-8-quinolinolato)aluminum(III)-μ-oxo-bis(2-methyl-8-quinolinolato)aluminum(III)
CO-5: Indium trisoxine [alias,tris(8-quinolinolato)indium]
CO-6: Aluminum tris(5-methyloxine) [alias,tris(5-methyl-8-quinolinolato) aluminum(III)]
CO-7: Lithium oxine [alias,(8-quinolinolato)lithium(I)]
CO-8: Gallium oxine [alias,tris(8-quinolinolato)gallium(III)]
CO-9: Zirconium oxine [alias,tetra(8-quinolinolato)zirconium(IV)]

Other classes of useful host materials include, but are not limited to: derivatives of anthracene, such as 9,10-di-(2-naphthyl)anthracene and derivatives thereof, distyrylarylene derivatives as described in U.S. Pat. No. 5,121,029, and benzazole derivatives, for example, 2,2′,2″-(1,3,5-phenylene)tris[1-phenyl-1H-benzimidazole].

Useful fluorescent dopants include, but are not limited to, derivatives of anthracene, tetracene, xanthene, perylene, rubrene, coumarin, rhodamine, quinacridone, dicyanomethylenepyran compounds, thiopyran compounds, polymethine compounds, pyrilium and thiapyrilium compounds, fluorene derivatives, periflanthene derivatives and carbostyryl compounds.

It is advantageous in this invention that the emission spectrum be relatively narrow so that each color record of the receiving media is properly exposed. This can be accomplished through optical effects, but can also be accomplished through choice of materials. For example, trivalent lanthanide compounds are known to give extremely narrow emission as taught in WO 98/55561.

The above classes of dopants typically can yield emission from 450 to 650 nm and one skilled in the art can select the appropriate materials for use in this invention. It is true that materials that emit at 650 nm and longer are not as well developed for OLED applications since displays typically don't require this range. However, materials are known that emit in this region. For example, compounds as taught in EP 1 073 128 have emission in this range. Specifically, a useful class is shown in Formula I. 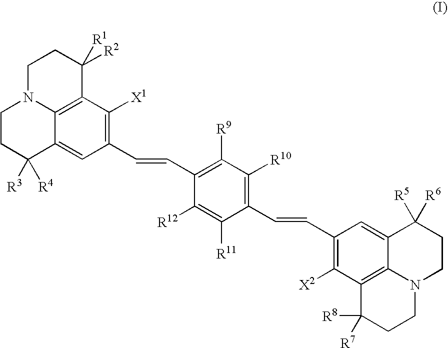
wherein X1 and X2 independently represent a hydrogen atom, a hydroxyl group or an alkoxy group such as a methoxy group, R1 to R8 independently represent a lower alkyl group such as a methyl group, and R9 to R12 independently represent an electron attracting group such as a cyano group.

Preferred thin film-forming materials for use in forming an electron-transporting layer of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary oxinoid compounds were listed previously.

Other electron-transporting materials include various butadiene derivatives as disclosed in U.S. Pat. No. 4,356,429 and various heterocyclic optical brighteners as described in U.S. Pat. No. 4,539,507. Benzazoles and triazines are also useful electron-transporting materials.

In some instances, electron-transporting and light-emitting layers can optionally be collapsed into a single layer that serves the function of supporting both light emission and electron transport. These layers can be collapsed in both small molecule OLED systems and in polymeric OLED systems. For example, in polymeric systems, it is common to employ a hole-transporting layer such as PEDOT-PSS with a polymeric light-emitting layer such as PPV. In this system, PPV serves the function of supporting both light emission and electron transport.

Desirable cathode materials have good film-forming properties to ensure good contact with the underlying organic layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) and a thicker layer of conductive metal. The EIL is situated between the cathode and the organic layer (e.g., ETL). Here, the EIL preferably includes a low work function metal (such as lithium) or metal salt, and if so, the thicker conductor layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059,861; 5,059,862, and 6,140,763.

For microcavity applications where the cathodes are semi-transparent, metals must be thin or one must use transparent conductive oxides in combination with a partially reflective layer, or a combination of these materials. Optically transparent and semi-transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No.5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, and U.S. Pat. No. 6,278,236. Cathode materials are typically deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimator “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. Nos. 5,851,709 and 6,066,357) and inkjet method (U.S. Pat. No. No. 6,066,357). While all organic layers may be patterned, it is most common that only the layer emitting light is patterned, and the other layers may be uniformly deposited over the entire device.

OLED devices of this invention can employ various well-known optical effects in order to enhance its properties if desired. This includes optimizing layer thicknesses to yield maximum light transmission, providing dielectric mirror structures, providing anti glare or anti-reflection coatings over the device, providing a polarizing medium over the device, or providing colored, neutral density, or color conversion filters over the device. Filters, polarizers, and anti-glare or anti-reflection coatings may be specifically provided over the cover or as part of the cover. In another embodiment of this invention, the OLED elements may emit white light and a RGB filter array is provided over the white-emitting OLED elements to provide a full color device.

The invention has been described in detail with particular reference to certain preferred embodiments thereof, but it will be understood that variations and modifications can be effected within the spirit and scope of the invention.

### Parts List

12 computer
14 local disk
16 external network
17 image processing sub-system
18 network interface electronics
19 embedded processor
20 framestore electronics
22,62 photosensitive medium
24 modulator assembly
26 resize electronics
28 aperture correction electronics
30 color correction electronics
32 tone scale calibration electronics
34 OLED driver/uniformity correction electronics
36 film gate
38 media transport assembly
41 media supply canister
42 media take-up canister
50,80,100 red two-dimensional OLED modulator
52,74,102 green two-dimensional OLED modulator
54,76,104 blue two-dimensional OLED modulator
56 X-cube diachroic combiner
58,106,108,110 focusing lens
70, 72 dichroic beam splitters
78 focusing lens
84,112,138,156 photosensitive medium
98 modulator assembly
130,132,134,152 lenslet array
150 two-dimensional stacked SOLED modulator
303 anode
305 hole-injecting layer
307 hole-transporting layer
309 light-emitting layer
311 electron-transporting layer
313 cathode
350 voltage/current source
360 conductive wiring
600 OLED Modulator
601 support
602 Organic insulator layer
603 Organic insulator layer
605 monochrome light-emitting organic layer
606 Conductive wiring
610 anode pad
640 cathode
Xn X-direction signal lines where n is an integer
Ym Y-direction signal lines where m is an integer
Vddn power supply lines
TSnm thin film transistors for switching
TCnm thin film transistors for current control
ELnm OLED devices
Cnm capacitors
ELECnm electrical wiring, capacitors, and transistors in each pixel

What is claimed is:

1. A method of printing a plurality of image frames from a digital image file of a motion picture sequence to a photosensitive medium comprising one or more light-sensitive recording layers, comprising the steps of:
a) providing at least one two-dimensional OLED modulator, wherein the OLED modulator comprises an array of independently activatable microcavity OLED elements, each OLED element defining an optical cavity for reducing the angle of emission of light from the OLED element and tuning the light output of the OLED element to a limited spectral band emmitance range wavelength matched to the spectral sensitivity of a light-sensitive recording layer of the photosensitive medium;
b) responding to the digital image file to independently activate the OLED elements in the two-dimensional OLED modulator to provide visual images corresponding to each frame of the motion picture sequence; and
c) moving the photosensitive medium past the visual images to illuminate different portions the medium to record the motion picture sequence on the medium.

2. The method of claim 1, further comprising magnifying or de-magnifying and focusing the visual images on an image plane of the photosensitive medium.

3. The method of claim 2, wherein the microcavity OLED elements have an output divergence angle matched to optical collection and focusing components used to magnify or de-magnify and focus the visual images on the image plane.

4. The method of claim 1, further comprising responding to the digital image file to manipulate the digital information contained therein to achieve desired effects in the image to be printed to the photosensitive medium.

5. The method of claim 4, wherein image processing steps performed on the digital image file include one or more of color correction, aperture correction, size, tone scale, uniformity, sharpening, file format conversion or combinations thereof.

6. The method of claim 1, wherein the at least one two-dimensional OLED modulator is a monochrome two-dimensional OLED modulator.

7. The method of claim 6, wherein the digital image file comprises a digital image file of a color motion picture sequence, the photosensitive medium comprises two or more light-sensitive recording layers sensitized to different wavelengths, and two or more monochrome two-dimensional OLED modulators comprising arrays of independently activatable microcavity OLED elements having light outputs tuned to wavelengths matched to the spectral sensitivities of the light-sensitive recording layers of the photosensitive medium are provided,
and further comprising combining visual monochromatic images provided from the two or more monochromatic two-dimensional OLED modulators in response to the digital image file to create visual color images corresponding to each frame of the color motion picture sequence, and moving the photosensitive medium past the visual color images to illuminate different portions of the medium to record the color motion picture sequence on the medium.

8. The method of claim 7, wherein the photosensitive medium comprises red, green and blue light-sensitive recording layers, and red, green and blue monochrome two-dimensional OLED modulators comprising arrays of independently activatable microcavity OLED elements having red, green and blue light outputs tuned to wavelengths matched to the spectral sensitivities of the light-sensitive recording layers of the photosensitive medium are provided.

9. The method of claim 6, wherein the digital image file comprises a digital image file of a color motion picture sequence, the photosensitive medium comprises two or more light-sensitive recording layers sensitized to different wavelengths, and two or more monochrome two-dimensional OLED modulators comprising arrays of independently activatable microcavity OLED elements having light outputs tuned to wavelengths matched to the spectral sensitivities of the light-sensitive recording layers of the photosensitive medium are provided,
wherein the OLED modulators are arranged sequentially along a photosensitive medium transport path and further comprising sequentially registrating and recording visual monochromatic images provided from the two or more monochromatic two-dimensional OLED modulators on the photosensitive medium in response to the digital image file to record the color motion picture sequence on the medium.

10. The method of claim 9, wherein the photosensitive medium comprises red, green and blue light-sensitive recording layers, and red, green and blue monochrome two-dimensional OLED modulators comprising arrays of independently activatable microcavity OLED elements having red, green and blue light outputs tuned to wavelengths matched to the spectral sensitivities of the light-sensitive recording layers of the photosensitive medium are provided.

11. The method of claim 6, wherein the digital image file comprises a digital image file of a monochromatic motion picture sequence, and a single monochrome two-dimensional OLED modulator is used to provide visual monochromatic images in response to the digital image file to create visual color images corresponding to each frame of the motion picture sequence.

12. The method of claim 1, wherein the digital image file comprises a digital image file of a color motion picture sequence, the photosensitive medium comprises two or more light-sensitive recording layers sensitized to different wavelengths, and the OLED modulator is a multi-color OLED modulator comprising an array of independently activatable microcavity OLED elements including different elements tuned to match the different spectral sensitivities of the two or more light-sensitive recording layers of the photosensitive medium; and the multi-color OLED modulator is used in response to the digital image file to create visual color images corresponding to each frame of the motion picture sequence.

13. The method of claim 12, wherein the photosensitive medium comprises red, green and blue light-sensitive recording layers, and the multi-color OLED modulator comprises an array of independently activatable red, green and blue microcavity OLED elements tuned to match the red, green and blue spectral sensitivities of the light-sensitive recording layers of the photosensitive medium.

14. The method of claim 1, wherein the microcavity OLED elements comprise first and second electrode layers and at least one light-emitting organic layer disposed between the first and second electrode layers, wherein one of the electrode layers is semitransparent and reflective and the other one is essentially opaque and reflective.

15. The method of claim 14, wherein the first and second electrode layers are metallic.

16. The method of claim 15, wherein metallic electrodes include metals or metal alloys selected from the group including Ag, Au, Al, and Mg.

17. An apparatus for printing a plurality of image frames from a digital image file of a motion picture sequence to a photosensitive medium comprising one or more light-sensitive recording layers, comprising:
a) at least one two-dimensional OLED modulator, wherein the OLED modulator comprises an array of independently activatable microcavity OLED elements, each OLED element defining an optical cavity for reducing the angle of emission of light from the OLED element and tuning the light output of the OLED element to a limited spectral band emmitance range wavelength;
b) means for receiving and storing a digital image file of a motion picture sequence;
c) means for responding to the digital image file to independently activate the OLED elements in the two-dimensional OLED modulator to provide visual images corresponding to each frame of the motion picture sequence; and
d) means for moving a photosensitive medium past the visual images to illuminate different portions the medium to record the motion picture sequence on the medium.

18. The apparatus of claim 17, further comprising optics for magnifying or de-magnifying and focusing the visual images on an image plane of the photosensitive medium.

19. The apparatus of claim 1, wherein the microcavity OLED elements comprise first and second electrode layers and at least one light-emitting organic layer disposed between the first and second electrode layers, wherein one of the electrode layers is semitransparent and reflective and the other one is essentially opaque and reflective.

20. The apparatus of claim 19, wherein the first and second electrode layers are metallic.
